(19) United States
(12) Patent Application Publication
(10) Pub. No.: US 2007/0166194 A1
(43) Pub. Date: Jul. 19, 2007

(54) Automatic blood analyzer

(76) Inventor: Koichi Wakatake, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/569,473

(22) PCT Filed: Aug. 27, 2003
(86) PCT No.: PCT/JP03/10869

§ 371 Date: Nov. 14, 2006

(51) Int. Cl. G01N 35/00

(52) U.S. Cl. 422/64; 436/43

(57) ABSTRACT

This relates to an automatic blood analyzer that enables to test many items by using a small quantity of blood from infants and critically ill patients that is not possible for tests by conventional automatic blood analyzers, and obtains highly accurate measured data useful for early curative effect. Between the sample nozzle of the sample dispensing device and the washing water supply line, two dispensing lines of a dispensing line by a micro syringe that performs dispensing of more than a prescribed quantity and a pressure dispensing line that performs dispensing of less than a prescribed quantity, and a wipeout device that wipes out the outer surface of each dispensing nozzle are placed before and after a working of dispensing of the sample and the reagent.

### TECHNICAL FIELD

This invention relates to an automatic blood analyzer that expands a sample dispensing range thereof to the unit of nanoliter (nl) and improves the accuracy of measurement, and more particularly to an automatic blood analyzer having two functions of dispensing sample by micro syringe pump and pressure.

### BACKGROUND ART

Quite a few automatic blood analyzers which analyze blood components or urinary constituents such as GOT, GPT, ALP and TP are used at medical sites such like medical institution, and the test results are appreciated as therapeutic data. Currently, since automatic blood analyzers for general biochemistry are usually based on a sample dispensing method of so-called “micro syringe method” that requires three microliters or a minimum dispensing quantity guaranteeing accuracy, the analyzers generally requite 3-30 microliters per test. Besides, automatic immunochemical analyzers usually require 10-100 microliters.

Accordingly, the quantity of blood sample and that of reagent are determined with three microliters as a minimum quantity or a guarantee of less than 2% of CV (coefficient of variation) that is a limit of conventional dispensing technology, or an analytical condition of individual test items. Therefore, in the case of testing infants and critically ill patients that have strict difficulty in blood diagram, immediate and accurate clinical examination can be performed only on a limited number of items at present. Furthermore, since the accuracy of measurement is still insufficient, different medical institutions have different measured data, and presently have difficulties in judging early therapeutic effects.

This invention has been achieved in consideration of the present situation, and the purpose thereof is to provide an automatic blood analyzer that enables multiple blood tests for infants and critically ill patients and produces measured data with high accuracy that are helpful for early therapeutic effect.

### DISCLOSURE OF INVENTION

This invention has been made to achieve the above purpose. The invention described in Claim 1 provides an automatic blood analyzer based on a technology, involving the following steps. After a sample nozzle attached to a sample dispensing device has suctioned a sample required for items of measurement from a sample vessel into a reaction vessel, a liquid removing portion removes the sample adhered to an outer surface of the sample nozzle, and then the sample nozzle is delivered to the reaction vessel. Next, after having dispensed a required quantity of the sample into the reaction vessel, the reaction vessel is delivered to a reagent dispensing position. After a reagent nozzle has suctioned a prescribed quantity of a reagent for items of measurement at the reagent dispensing position, a liquid adhesion removing portion removes the reagent adhered to an outer surface of the reagent nozzle, and then dispenses a required quantity of the reagent from the reagent nozzle attached to the reagent dispensing device into a reaction vessel. Next, the reaction sample reacted by warming is optically measured by a prescribed wave length. The automatic analyzer is characterized in that: two dispensing lines of a micro syringe dispensing line dispensing a volume of more than a prescribed sample quantity and a pressure dispensing line dispensing a volume of less than a prescribed sample quantity are connected with a three-way valve between the sample nozzle attached to the sample dispensing device and a washing water supply line; and the above micro syringe dispensing line is equipped with a two-way valve, and the pressure dispensing line is equipped with a two-way valve and a pressure maintenance portion. Moreover, dispensing from the sample and the reagent to the reaction tube may be performed in an order from the reagent to the sample, but an order from the sample is more effective from the viewpoint of stirring effect. A preferred embodiment of the invention will be described with reference to the sample dispensing ahead of the reagent.

According to the invention, all test conditions based on a quantity of sample and a quantity of reagent required for conventional automatic blood analyzers are prescribed on the basis of a dispensing quantity of minimum sample. As described in Claim 2, the invention is, however, equipped with a pressure dispensing line that can measure the lowest limit of the dispensing quantity to the unit of nanoliter (nl) as well as a quantity at the micro syringe line.

The invention provides a reliable working of discharging and dispensing of a prescribed, slight quantity (nanoliter) of sample, where a high-speed plunger valve is accurately controlled over open and close thereof in a militime.

Moreover, the invention according to Claim 3 provides the liquid adhesion removing portion that has a two-ply fluid absorption tape, a supply reel and a take-up reel for the fluid absorption tape, and a means for opening the fluid absorption tape in V-formation. Accuracy of dispensing is improved in a manner that the sample nozzle, a reagent nozzle and a stirrer are inserted in between the fluid absorption tape opened in V-formation for contacting with the fluid absorption tape and remove the liquid adhered to an outer surface of the above each nozzle or the stirrer, and prevent the liquid adhered to the outer surface of nozzles from influencing on the dispensing quantity of the sample or the reagent. In addition, complete prevention of cross contamination by the reaction liquid adhered to the stirrer and the washing water performs a highly reliable measurement

### BRIEF DESCRIPTION OF THE DIAGRAMS

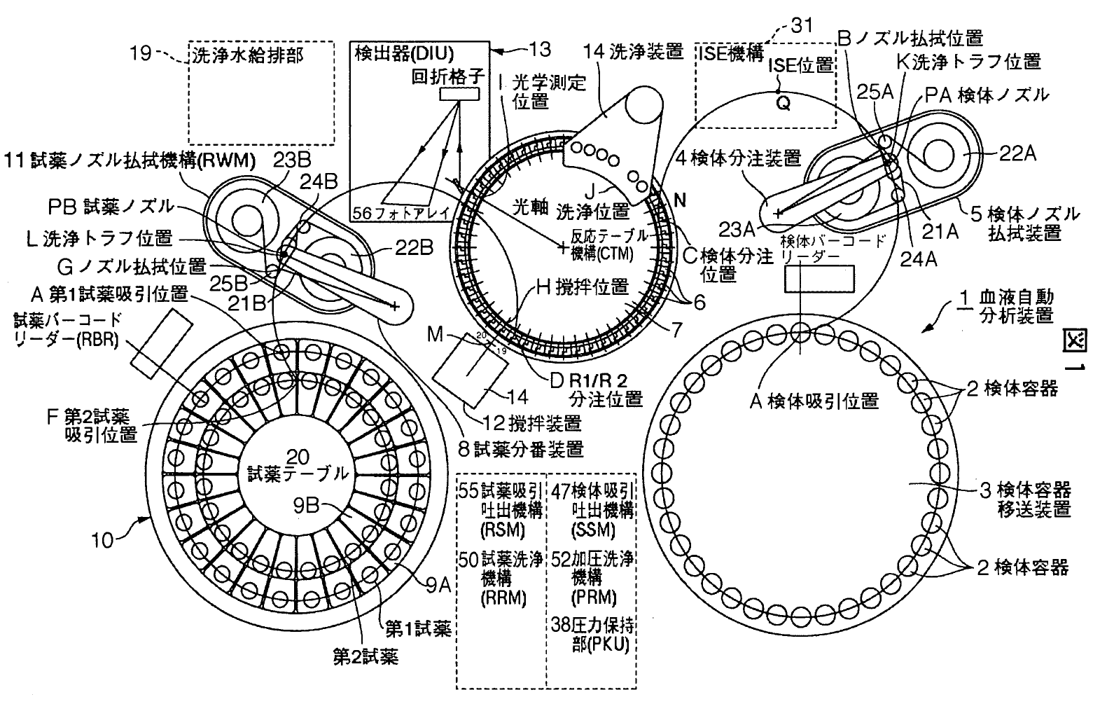

FIG. 1 is an explanatory diagram of mechanism that shows a principle of an automatic blood analyzer according to the embodiment of the invention.

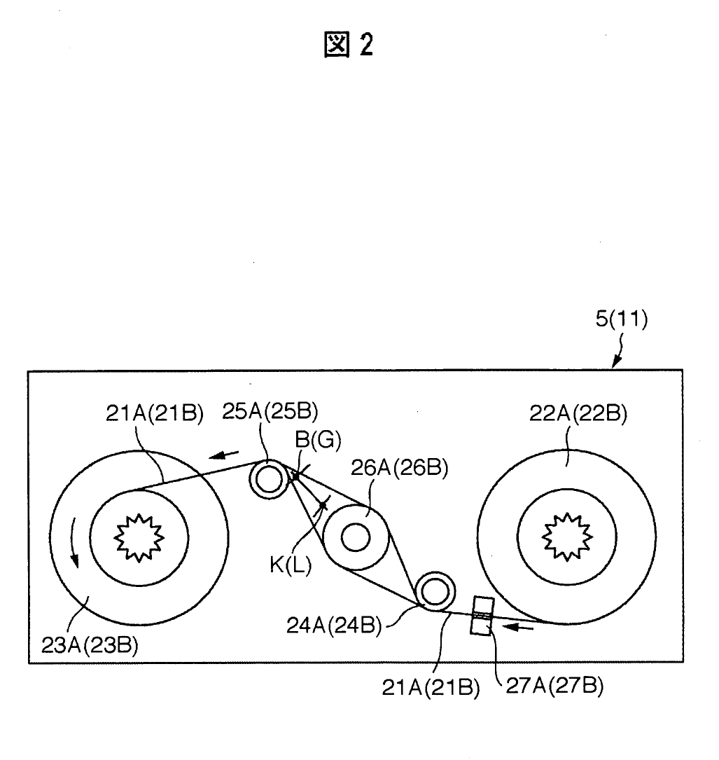

FIG. 2 is an explanatory plan view that shows a mechanism of a nozzle wipeout device of the automatic blood analyzer.

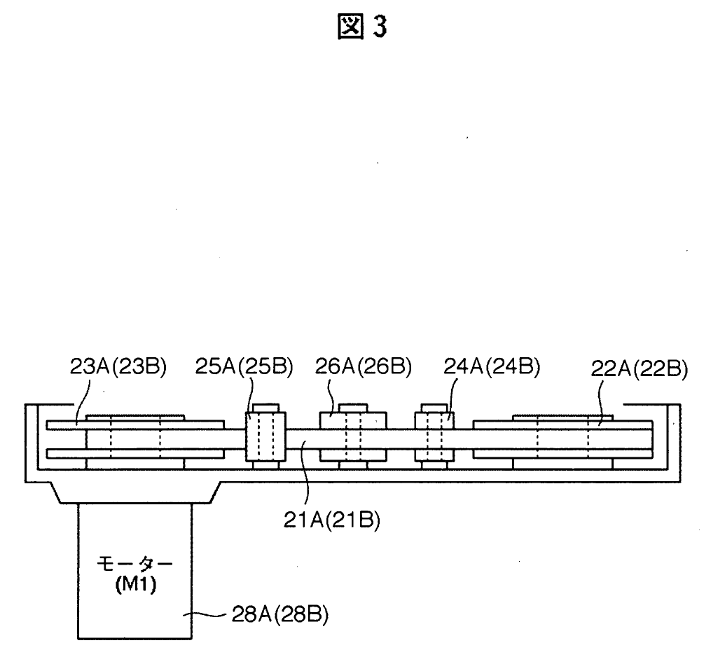

FIG. 3 is an explanatory elevation view of mechanism of a nozzle wipeout device of the automatic blood analyzer.

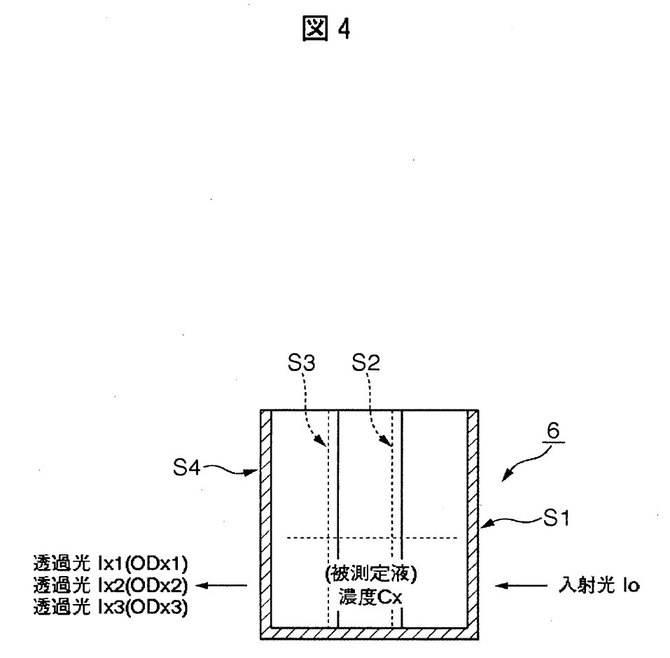

FIG. 4 is a cross-section diagram of a reaction vessel that is used to the automatic blood analyzer.

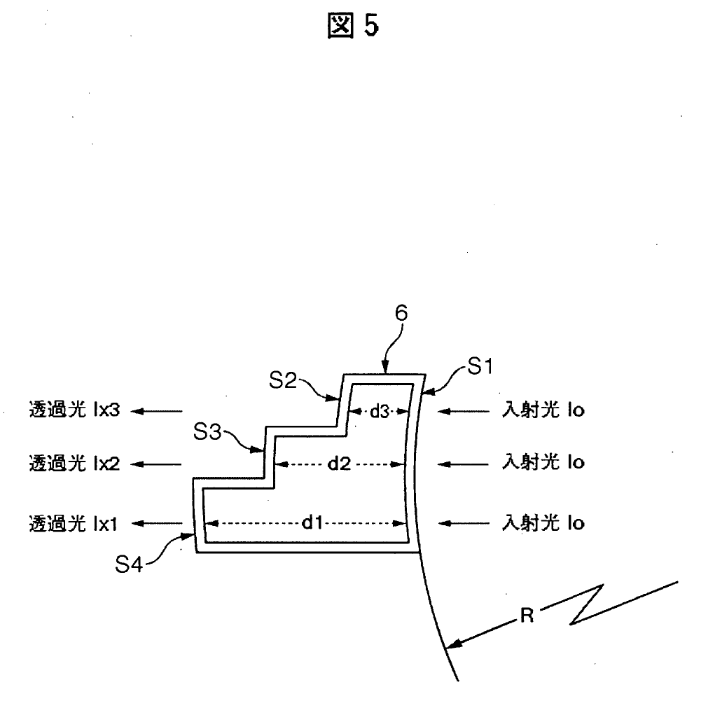

FIG. 5 is a plan view of a reaction vessel of the automatic blood analyzer.

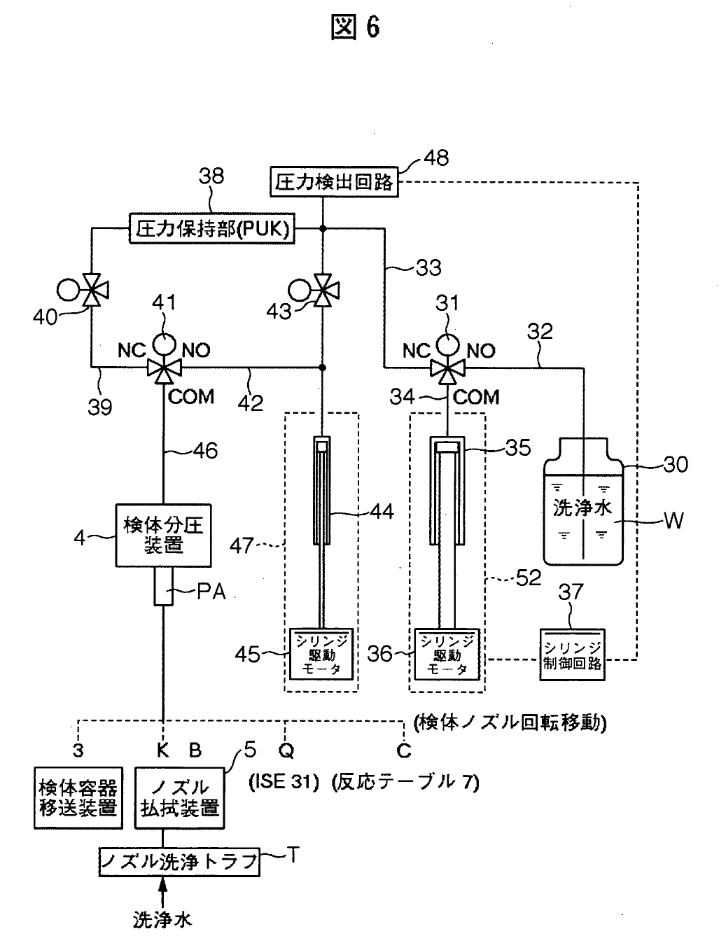

FIG. 6 is an explanatory diagram of a flow-channel piping of a sample dispensing system of the automatic blood analyzer.

### DESCRIPTION OF THE PREFERRED EMBODIMENTS

Now, preferred embodiments of the present invention will be described with reference to the accompanying diagrams.

As shown in FIG. 1, an automatic blood analyzer 1 in the embodiment is constituted of: a sample vessel delivery device 3, holding a plurality of sample vessels 2 in loop-formation; a sample dispensing device 4, suctioning a slight amount of sample from the inside of the sample vessel 2 at a sample suction position A; a liquid adhesion removing device 5, removing the sample adhered to the outer surface of a sample nozzle PA attached to the sample dispensing device 4 at a liquid adhesion removing position B; a reaction table 7, holding a plurality of reaction vessels 6 in which the sample sucked into the sample nozzle PA is dispensed at a sample dispensing position C and trindles the vessels; a reagent dispensing device 8, dispensing a primary reagent and a secondary reagent according to the items of measurement into the reaction vessel 6 at a reagent dispensing position D; a reagent supply device 10, holding a reagent vessel 9 contained with the primary reagent and the secondary reagent according to the items of measurement, in loop-formation, and performing a rotatory delivery to a primary reagent suction position E or a secondary reagent suction position F; a reagent adhesion removing device 11, removing the sample adhered to the outer surface of a reagent nozzle PB attached to the above reagent dispensing device 8 at a liquid adhesion removing position G; a stirring device 12, stirring for homogenizing a mixed condition of the sample contained in the reaction vessel 6 and the reagent at a stirring position H; a detector sensor 13, exposing a light to be measured according to the items of measurement to the reaction liquid at a light measurement position I; an arithmetic circuit (not shown), converting the data measured by the detector sensor 13 into a voltage for arithmetic processing and performing a quantitative analysis on the items of measurement; a reaction vessel washing device 14, ejecting the measured reaction liquid in the reaction vessel 6 at a washing position J and washing the inside of the reaction vessel; a control circuit (not shown), controlling drive for an organic, continuous operation of the above functions; and a printer (not shown), printing out the measured data in association with information of the sample. The analyzer 1 simultaneously measures two reagents for 24 items, with a process capacity of 300 tests per hour. For this reason, the reaction table 7 is equipped with 48 pieces of three-light-path cells. In FIG. 1, the code K shows a washing trough position of a sample nozzle wipeout device 5, the code L a washing trough position of a reagent nozzle removing device 11, and the code M a washing trough position of the stirring device 12, respectively Furthermore, FIG. 1 does not show an “electrolyte analysis unit”, but the invention can have it built in as is the case with conventional automatic blood analyzers.

The sample vessel delivery device 3 employs a turntable method, and is formed so as to deliver the sample vessel 2 to the sample suction position. A with an intermittent pitch at a regular interval. Samples to be set are a general sample, a photometry sample, an emergency sample, an accuracy controlled sample and the like. “Bar code number” and “turntable number” identify samples.

Dispensing of sample is performed in the following manner: the sample nozzle PA rises from a washing trough position K of the sample nozzle wipeout device 5 to a nozzle wipeout height, rotates to a nozzle wipeout position B for removing the washing water adhesion and suctions samples at the sample suction position A; the sample nozzle PA again removes the blood adhesion at the liquid adhesion removing position B and is delivered to the sample dispensing position C of the reaction table 6 for dispensing a requirement of suctioned sample into a reaction tube at the position C and descends to a nozzle washing trough T at the washing trough position K of the sample nozzle wipeout position 5; and the sample nozzle PA is washed for completion of the process. Delivery of the sample nozzle PA is performed in the sample dispensing device 4, and sample suction is performed by a sample dispensing system (to be described later). Moreover, washing of the inside of the sample nozzle PA is performed with the washing water from a pressurized washing device 52.

As shown in FIGS. 2 and 3, The sample nozzle wipeout device 5 is formed so that a long two-ply fluid absorption tape 21A can be taken up from a supply reel 22A to a take-up reel 23A at a prescribed timing at a prescribed quantity. A pair of a guide roller 24A and a guide roller 25A is placed between the above reels 22A and 23A where the fluid absorption tape 21A is suspended. A separation roller 26A is placed between the guide roller 24A and the guide roller 25A for separating the superimposed fluid absorption tape 21A in V-formation. Between the guide roller 25A and the separation roller 26A, the nozzle wipeout position B and the washing trough position K are placed. The code 27A in FIG. 2 is a sensor for detecting whether the fluid absorption tape 21A exists or not, and the code 28A in the same figure is a motor for taking up the fluid absorption tape 21A.

The sample nozzle PA that absorbed the sample in this manner descends to the nozzle wipeout height at the washing trough position K between the guide roller 25A and the separation roller 26A of the sample nozzle wipeout device 5. Then, the sample nozzle PA rotates to the fluid absorption removing position B and the nozzle PA contacts with the fluid absorption tape 21A. Accordingly, the sample adhered to the outer surface of the nozzle PA is absorbed and a dispensing quantity can be exactly controlled. After the sample nozzle PA has contacted with the fluid absorption tape 21A at the position B, when the sample nozzle PA rotates, outer circumferential thereof can be contacted with the fluid absorption tape 21. Moreover, for the sample nozzle PA, the inside and the outside of the nozzle are washed in the washing trough at the washing trough position K of the sample nozzle wipeout device 5 after the sample has been dispensed. That is to say that, the sample nozzle PA descends at the washing trough position K between the guide roller 25A and the separation roller 26A of the sample nozzle wipeout device 5 until the sample nozzle PA is soaked in the wash fluid in the washing trough. The inside surface is washed with the wash fluid from a washing syringe and the outside surface is washed with the wash fluid that is to be delivered to the trough. When a working of suctioning and dispensing is completed, a tip of the sample nozzle is soused in the washing trough.

Accordingly, when a suctioning of the sample starts, the sample suction is performed after the washing water adhered to the outer surface of the nozzle has been wiped out at the wipeout position B of the sample nozzle wipeout device 5. That is to say that, the sample nozzle PA rises up to the wipeout height at the washing trough position K, then rotates to the wipeout position B. The nozzle PA contacts with the fluid absorption tape 21A and the sample adhered to the outer surface of the nozzle PA is removed.

Dispensing of reagent is performed in a manner: the reagent nozzle PB rises from a washing trough position L of the reagent nozzle wipeout position 11 to the nozzle wipeout height and rotates to a nozzle wipeout position G for wiping out the washing water adhesion. Next, the reagent nozzle PB suctions the reagent at the reagent suction position E (or F) and the blood adhesion is again wiped out at the liquid adhesion removing position G, and then is delivered to the sample dispensing position D of the reaction table 6. After a prescribed quantity of the suction reagent has been dispensed in a reaction tube at the position D, the reagent nozzle PB descends to the nozzle washing trough at the washing trough position L of the reagent nozzle wipeout device 11, where the reagent nozzle PB is washed for completion. Delivery of the reagent nozzle PB is performed by a reagent dispensing device 8, a working of suction and discharge of the reagent is performed with a reagent suction and discharge device 55. Furthermore, washing of the inside of the reagent nozzle PB is carried out with the washing water from a reagent washing device 50.

As shown in FIGS. 2 and 3, the reagent nozzle wipeout device 11 is formed so that a long two-ply fluid absorption tape 21B is taken up at a prescribed quantity in a prescribed timing from a supply reel 22B to a take-up reel 23B. A pair of a guide roller 24B and a guide roller 25B, suspended with the fluid absorption tape 21B, is placed between the reel 22B and the reel 23B. Between the guide roller 24B and the guide roller 25B, a separation roller 26B is placed for separating the superimposed fluid absorption tape 21B in V-formation. Besides, the nozzle wipeout position G and the washing trough position L are set between the guide roller 25B and the separation roller 26B. In FIG. 2, the code 27B is a sensor for detecting whether the fluid absorption tape 21B exists or not, and the code 28B is a motor for taking up the fluid absorption tape 21B.

The reagent nozzle PB suctioned the reagent in this way descends to the nozzle wipeout height at the washing trough position L between the guide roller 25B and the separation roller 26B of the reagent nozzle wipeout device 11, and rotates to the liquid adhesion removing position G. Since the nozzle PB contacts with the fluid absorption tape 21 and thus the reagent adhered to the outer surface of the nozzle PB is taken up, a dispensing quantity can be exactly controlled.

Moreover, for the reagent nozzle PB, the inside and the outside of the nozzle are washed at the washing trough position L of the reagent nozzle wipeout device 11 after the reagent has been dispensed. That is to say that, the reagent nozzle PB descends at the washing trough position L between the guide roller 25B and the separation roller 26B of the sample nozzle wipeout device 11 until the nozzle PB is soaked in the wash fluid of the washing trough. The inside surface is washed with the wash fluid from the washing syringe, and the outside surface is washed with the wash fluid that is to be delivered to the trough. When a working of suction and dispensing is completed, the tip of the reagent nozzle is soused in the washing trough.

Accordingly, when the sample suction starts, a reagent suction is performed after the washing water adhered to the outer surface of the nozzle has been wiped out at the wipeout position G of the reagent nozzle wipeout device 11. That is that, the reagent nozzle PB rises up to the wipeout height at the washing trough position L, then rotates to the wipeout position G. The nozzle PB contacts with the fluid absorption tape 21B, and the reagent adhered to the outer surface of the nozzle PB is removed.

As shown in FIGS. 4 and 5, the reaction vessel 6 is made of translucent material such like glass in a tubular shape with bottom as well as a face receiving incident light S1 is laid in arc formation towards the center of a circular where the reaction vessels are placed. Moreover, transmission faces S2, S3 and S4 as outgoing surface are also laid in steps on the flat, in arc formation. In this embodiment, light path length formed between the outgoing surfaces S2, S3 and S4 of these steps, and the face receiving incident light S1 has three types: a shortest-length light path d1, a middle-length light path d2, and a long-length light path d3. In this invention, the light path length is not limited to three types of the embodiment and may be formed so as to obtain more than two types of the light path length.

In FIGS. 4 and 5, the code Io is an incident light, I×1 a transmitted light in the S4 portion, I×2 a transmitted light in the S3 portion, I×3 a transmitted light in the S2 portion, Cx a concentration of liquid to be measured, OD×1 an absorbance that the concentration Cx is measured at the S4 portion, OD×2 an absorbance that the concentration Cx is measured at the S3 portion, and OD×3 an absorbance that the concentration Cx is measured at the S2 portion.

Since the blood analysis method employing this reaction vessel 6 is as same as the Patent 2002-264375 that the applicant has previously proposed, detailed explanation is omitted here.

In this embodiment, the reaction table 7 is formed so as to deliver each reaction vessel 6 by rotational transfer from the sample dispensing position C via the reagent dispensing position D and the stirring position H to the optical measurement position I in turn. In this reaction table 7, a reaction fluid between the sample and the reagent is controlled by temperature control circuit (not shown) so as to maintain constant temperature, namely, 37 degrees C. +/−0.1 degrees C. Further, the reagent is warmed up to about 37 degrees C. by the reagent dispensing device 8 and dispensed into a reaction tube.

The reagent dispensing device 8, having the reagent nozzle PB that suctions reagent, dispenses a primary reagent or a secondary reagent according to the items of measurement in the reaction vessel 6 containing the dispensed sample, at the reagent dispensing position D. The reagent nozzle PB suctions a prescribed quantity of the primary reagent or the secondary reagent according to the items of measurement at the primary reagent suction position E or the secondary reagent suction position F. Then, the reagent nozzle PB is delivered to the reagent adhesion wipeout position G, and the reagent adhered to the outer surface of the reagent nozzle PB is wiped out at the position G. In this manner, quantity of the reagent to be dispensed can be exactly controlled.

In this embodiment, for a reagent vessel 9 involving the primary reagent and the secondary reagent, a primary reagent housing vessel 9A is housed on the outside of the vessel, and a secondary reagent housing vessel 9B is housed in the vessel and the reagent is cooled at about 10-12 degrees C.

The reagent supply device 10 delivers the above reagent vessel 9A and the reagent vessel 9B housing reagent according to the items of measurement to a primary reagent dispensing position E or a reagent dispensing position F by control over clockwise and counter rotations. Furthermore, each reagent vessel has “bar code label” for controlling and controls types, production date of the reagent and the like.

The stirring device 12 is used for homogenizing a reaction between the dispensed sample and the reagent in the reaction vessel 9, and inserted with a stirrer (not shown) in the reaction liquid for swinging and rotation. The stirrer that completed stirring is washed for preventing cross contamination. The stirring device 12 may be equipped with a wipeout device which has the same formation as the fluid adhesion wipeout device 5 that wipes out the reaction fluid adhered to the outer surface of the stirrer after use. This is not particularly shown here.

A detection portion 13 is a spectrophotometer using a diffraction grating (which can be replaced with a wave length conversion method using filter) as a light dispersion element. The portion 13 is formed so as to disperse the light to be measured from the light source that is transmitted through the reaction vessel 6 into a monochromatic light so that a plurality of the light receiving elements (photo array 56) are arranged on a focal point of the diffraction grating. From these, output from the light receiving element according to the items of measurement are delivered to the arithmetic circuit.

In the arithmetic circuit, the output data are computed based on the prescribed computation method, and the computed data are printed out from the printer.

Furthermore, the control circuit is a circuit that entirely controls the automatic blood analyzer and performs communication with the outer CPU. The control circuit, equipped with a storage that automatically stores and saves the measured data and the reaction time course data and trouble data of each reaction vessel 6, can immediately make a test report in real time by reading out the above measured data from the outer output terminal to the outer computer.

Next, the sample dispensing system of the automatic blood analyzer in this embodiment will be described based on FIG. 6.

The code 30 is a vessel containing a washing water, the code 31 is a three-way valve that changes a flow channel 34 with a flow channel 32 or a flow channel 33, the code 35 is a washing syringe for washing the suction system and constantly pressurizing the flow channel 33, the code 36 is a syringe drive motor, the code 37 is a syringe control circuit, the code 38 is for example a pressure maintenance portion that is formed in coiled shape at the middle of the a flow channel 39, the code 40 is a two-way valve (high-speed plunger valve) that breaks and opens the sample nozzle PA and the pressure maintenance portion 38 via the three-way valve 41, the code 41 is a three-way valve that changes the flow channel 39 and a flow channel 42, the code 42 is a flow channel that connects the sample nozzle PA and the micro syringe 43 via the three-way valve 41, the code 43 is a two-way valve that breaks and opens the flow channel 42 and the flow channel 33, the code 44 is a micro syringe that suctions the sample and dispenses the sample of about more than three microliters, the code 45 is a syringe drive motor that performs drive-control over a micro syringe 44, the code 46 is a flow channel that connects the sample nozzle PA with the three-way valve 41, the code 47 is a sample suction and discharge machine, the code 48 is a pressure sensing circuit that measures and controls the pressure inside the flow channel 39, and the code 52 is a pressurized wash machine.

The sample dispensing system of the automatic blood analyzer 1 in the embodiment has two flow channels: a sample suction and discharge flow channel 39 by the micro syringe 44 via the three-way valve 41, and the flow channel 42 that dispenses the sample by the pressure of the pressure maintenance portion. These systems are in the following conditions when the sample dispensing system starts operation. The three-way valve 41 is in a condition that a flow channel 46 and the flow channel 42 are connected. The sample nozzle PA and the micro syringe 44 are connected. The three-way valve 31 is connected with the flow channel 32 and the flow channel 34 so that it is connected with the syringe 35 and the washing water W. Furthermore, a two-way valve 40 and a two-way valve 43 are closed. The micro syringe 44 and the washing syringe 35 are positioned at the upper limit. From these conditions, working of each dispensing is performed in the below way.

When dispensing by the micro syringe 44, the sample vessel delivery device 3 first delivers a sample to the prescribed position A. Simultaneously, the sample nozzle PA removes the water adhered to the outer wall of the nozzle in the sample nozzle wipeout device 5, and delivers it to the sample suction position A of the sample vessel delivery device 3 via the sample dispensing device 4. At this time, bar code posted to the sample at the position A is read out by the sample bar code reader for confirming the test information.

Next the sample nozzle PA suctions a prescribed quantity of the sample from the inside of the sample vessel 2 at the sample suction position A. After suction of the sample, the sample adhered to the outer wall of the sample nozzle PA in the sample nozzle wipeout device is wiped out by the sample nozzle wipeout device 5, and a prescribed quantity of blood is dispensed into the reaction vessel 6 at the C position of the reaction table 7 or at the blood dispensing position Q of electrolyte (ISE). During the dispensing, the washing syringe 35 suctions a prescribed quantity of the washing water.

After sample dispensing, the sample nozzle PA is washed with a nozzle washing trough T at a nozzle washing position K. That is that, when the inside of the sample nozzle PA is washed, the three-way valve 31 is changed to the flow channel 33 and the two-way valve 43 is left open for flowing washing water from the flow channel 34 to the flow channel 33 to the flow channel 42 to the flow channel 46 by the washing syringe 35. Moreover, the two-way valve 43 is closed up and the two-way valve 40 is left open for flowing washing water from the flow channel 34 to the flow channel 33 to the flow channel 39 to the flow channel 46 by the washing syringe 35. When washing the outer side of the sample nozzle PA, washing water of the nozzle washing trough T is used.

Next, when dispensing a slight quantity by pressure, suction of the sample is performed via lines of the flow channel 46 and the flow channel 42 or via the flow channel 46 and the flow channel 39, and via the line of the pressure maintenance portion 38 at the sample micro syringe 44. The description explains of a case when the flow channel 46 and the flow channel 42 suction the sample. After the micro syringe 44 has suctioned a prescribed quantity of the sample, a three-way valve 41 switches over to the flow channel 46 and the flow channel 39. Further, at the same time, after the washing syringe 35 has suctioned a prescribed quantity of the washing water, the three-way valve 31 switches over to connect the flow channel 34 with the flow channel 33 and to connect the washing syringe 35 with the pressure maintenance portion 38. The syringe drive motor 36 is driven for boosting the washing syringe 35 to pressure the flow channel 33, the flow channel 34 and the pressure maintenance portion. Information of the pressure sensed by the pressure sensing circuit 48 is fed back to the syringe control circuit 37. The syringe drive motor 36 is controlled over drive in the syringe control circuit so as to keep the pressure maintenance portion constant.

On the other hand, the sample nozzle PA wipes out the sample adhered to the outer wall by the sample nozzle wipeout device 5 and then moves to the sample dispensing position C of the reaction table 7 or to the blood dispensing position Q of the electrolyte (ISE). The nozzle PA controls over on and off of the two-way valve 40 at a high speed for a period according to the dispensing quantity at a constant pressure, and dispenses blood into the reaction vessel 6 at the sample dispensing position C or into the electrolyte analysis position Q. Moreover, the high-speed plunger valve 40 is usually operated at a rated voltage and a rated current. Since long energization sets off a discharge of high temperature, it is desirable to descend the voltage and the current to the hold voltage and the hold current.

After sample dispensing, the sample nozzle PA is washed at the nozzle washing trough T of the nozzle washing position K as is the case with the sample nozzle PA that is dispensed with the micro syringe 44. After completion of such washing, the sample nozzle PA is reset to a completion status of the sample dispensing cycle operation as shown in FIG. 1, for the next working of sample dispensing.

Operation of the automatic blood analyzer 1 with the above sample dispensing system is explained based on the embodiment.

When voltage of the analyzer is switched on, the analyzer and the control device start operation of the system. Simultaneously, the light source lamp has an idling voltage lower than the rated voltage, and a temperature control circuit of the reaction table machine 7 and the reagent table machine 20 starts a temperature control. After about 20 minutes, a steady state is produced. During this time, prescribed preparation for measurement (sample, reagent, washing water and the like) is performed. When the analyzer becomes steady and the preparation of measurement is ready, the operation portion of the device instructs an operation start-up of measurement. Immediately, the light source lamp switches the idling voltage over to the rated voltage. When the light source lamp is not used for measurement, it is desirable to zero the voltage from the life. But, since it requires time before the voltage becomes stabilized after the light source lamp has been lighted, it has an arrangement of keeping the voltage at an idling voltage and shortening the stabilizing time after the rated voltage has been put on for initiating a start-up of the actual measurement earlier. However, even if the voltage is kept at the idling voltage, since it takes two to three minutes before it stabilizes, the real situation is kept in a suspended state when a start-up of measurement is commanded. That is that, since on-state of measurement can be confirmed at every cycle time (12 seconds in the case of 300 tests per hour of processing capacity) before the light source stabilizes, it initiates only the reaction table machine 7 according to the time sequence. Further, from some cycles before completion of standby time, the reaction vessel 6 before use, equipped with the reaction table 7, performs discharge, suction and ejection of washing water by the washing nozzle (not shown) of the washing device 14. This washing is simultaneously performed over a plurality of reaction tubes. Furthermore, the washing water infusion nozzle is equipped with a liquid surface sensor for preventing overflow and the last washing nozzle is equipped with a sensor for confirming complete ejection of washing water. Washing water is warmed up to about 37 degrees C. by the washing device 14 before being infused into the reaction tube.

The washing liquid W is supplied from the washing water supply and ejection portion 19 as shown in FIG. 1. The washing is repeated at a complete cycle time.

Besides, in the washing process, water blank of the reaction vessel 6 at the prescribed place is measured and the blank data is stored in the storage portion of the control circuit for administering damage or contamination of each reaction vessel 6.

When sample dispensing starts, dispensing of the primary reagent and stirring, and dispensing of the secondary reagent and stirring after a prescribed time, are continuously carried out. When sample according to the items of the first measurement is dispensed into a reaction tube at the position C of the reaction table 7, the reaction tube moves to the dispensing position D of the primary reagent in the same cycle (the next cycle can be used) and a prescribed quantity of the primary reagent is dispensed. When the sample and the reagent are dispensed, the sample vessel delivery device, the sample nozzle PA, the reagent nozzle PB, the sample dispensing device 4, the reagent dispensing device 8, the nozzle wipeout devices, the reaction table 7 and the reagent table 20 respectively work in the previously mentioned way. When actual measurement starts, each device performs the below measurement.

In other words, the reaction table 7 rotates so as to lead the reaction vessel 6 at the position N of the reaction table 7 to the sample dispensing position C.

Simultaneously, the sample nozzle PA moves to the sample suction position A by the sample dispensing device 4 for suctioning the sample and dispensing the sample into the reaction tube at the reaction tube position C. Next, the reaction table 7 rotates in the same cycle and delivers the reaction tube at the position C to the position D. The reagent nozzle PB moves to the reagent suction position E by the reagent dispensing device 8 for suctioning the primary reagent to dispense the primary reagent into the reaction tube at the reaction tube position D. When the sample is dispensed, if the reaction tube at the reaction tube position is a tube in which the sample and the primary reagent are dispensed, the secondary reagent is dispensed into the reaction tube. Simultaneously, stirring of the reaction tube that the secondary reagent is dispensed at the position H in the previous cycle is performed by the stirring device 12. Moreover, at the same time as dispensing of the primary reagent, stirring of the reaction tube that the primary reagent is dispensed at the position H in the previous cycle is performed by the stirring device 12.

In the analyzer, dispensing of the sample and the primary reagent, and stirring of the solution (sample and primary reagent) are carried out concurrently. Furthermore, dispensing of the secondary reagent and stirring of the solution (sample, primary reagent and secondary reagent), and washing of the reaction tube are concurrently performed.

The below explanation is a detailed behavior of the sample nozzle PA at sample dispensing and the reagent nozzle PB at reagent dispensing.

For sample dispensing, a sample is automatically supplied to the sample suction position A in the sample vessel delivery device 3.

Next, the sample nozzle PA rises to the nozzle wipeout height by the sample dispensing device 4, at the washing trough position K of the nozzle removing device 5, and rotates to the removing position B for initiating the sample nozzle PA to hit at a wipeout paper 21a and raises it as it stands to the upper position. At this time, the washing water adhered to the outer wall of the nozzle is wiped out. Furthermore, if the nozzle PA is hit at the wipeout paper 21a and rotates, the entire outer circumference of the nozzle is wiped out.

Next, the sample nozzle PA rotates to the sample suction position A and descends to the sample liquid surface at the sample suction position A. The liquid surface sensor detects the sample level and stops. Then, the sample nozzle PA suctions a required quantity of the sample by the micro syringe 44 attached to the sample suction and discharge device 47, and rises. The liquid surface sensor uses a capacitance method, and controls the descending speed of the sample nozzle PA according to the suction speed (liquid surface descending speed) according to the size of the sample vessel 2.

Then, the sample nozzle PA rotates to the washing trough position K of the sample nozzle wipeout device 5 and descends to the removing position. Then, the sample nozzle PA rotates to the removing position B, and contacts with a wipeout paper 21A to wipeout the blood adhered to the outer wall of the sample nozzle.

Next, the sample nozzle PA rotates to the sample dispensing position C of the reaction table 7, and dispenses the sample into the reaction vessel 6. Furthermore, in the case of dispensing into the ISE machine 31, the sample nozzle PA rotates to the sample dispensing position Q and dispenses the sample into the electrolyte analysis device.

The sample nozzle PA after sample dispensing returns to the washing trough position K of the sample nozzle wipeout device 5 and descends to the washing trough. The outer wall of the sample nozzle PA is washed with the washing water in the washing trough, and the inside wall is washed with the washing water from the syringe 35 attached to a pressurized washing device 38. In this manner, a cycle 1 of the sample dispensing is completed.

For reagent dispensing, a reagent table 20 attached to the reagent supply device 10 rotates so that the primary reagent according to the items of measurement comes to the primary reagent suction position E.

Next, after the reagent nozzle PB has risen to the nozzle wipeout height by the reagent dispensing device 8 and rotated to the wipeout position G to initiate the reagent nozzle PB to hit at a wipeout paper 21, the reagent nozzle PB is raised to the upper direction as it stands. At this time, the washing water adhered to the outer wall of the nozzle is wiped out. Further, if the nozzle PB rotates after it has hit at a wipeout paper 21B, the entire outer circumference of the nozzle is wiped out.

Thereafter, the reagent nozzle PB is delivered to the reagent suction position E of the reagent table 20.

At the primary reagent suction position E, the reagent nozzle PB descends to a liquid surface of the primary reagent and stops, and suctions a required quantity by the reagent syringe attached to the reagent dispensing device 8 and rises. The liquid surface of the reagent is detected by the liquid surface sensor of capacitance method.

Then, after the reagent nozzle PB has rotated to the washing trough position L of the reagent nozzle wipeout position 11 and descended to the wipeout height, the nozzle PB rotates to the nozzle wipeout position G to hit at the wipeout paper 21B, wipes out the reagent adhered to the outer wall of the nozzle, and rises.

Next, the reagent nozzle PB rotates to the reagent dispensing position D of the reaction table 7 and dispenses the reagent into the reaction vessel 6.

After having dispensed the primary reagent, the reagent nozzle PB rotates to the nozzle washing trough position L and descends to the inside of the nozzle washing trough and the outer wall of the nozzle is washed with the washing water. The inside wall suctioned the reagent is washed with the washing water from the washing syringe attached to the reagent washing device 50. In this manner, a cycle 1 of the reagent dispensing is completed.

Next, dispensing of the secondary reagent and stirring process will be described.

When the primary reagent and the sample are dispensed for a prescribed number of times, the secondary reagent starts dispensing into the reaction vessel 6 at the reagent dispensing position D at the same timing as that for sample dispensing.

That is that, after the primary reagent has been dispensed into the reaction vessel 6 at the reagent dispensing position D, the reaction vessel 6 rotates to the sample dispensing position C.

Next, the reagent table 20 rotates so that the secondary reagent according to the items of measurement comes to the secondary reagent suction position F.

After the reagent nozzle PB has risen up to the nozzle wipeout position by the reagent dispensing device 8, rotated to the wipeout position G and the reagent nozzle PB has hit at the wipeout paper 21B, the reagent nozzle PB is drawn up to the upper direction and the washing water adhered to the outer wall of the nozzle is wiped out.

Then, the reagent nozzle PB rotates to the secondary reagent suction position F of the reagent dispensing device, the reagent nozzle PB descends to the liquid surface of the secondary reagent at the reagent suction position F and stops. The reagent nozzle PB suctions a required quantity by the syringe attached to the reagent dispensing device 8, and rises. The liquid surface sensor of capacitive method detects the liquid surface of the reagent.

Next, the reagent nozzle PB rotates to the washing trough position L of the reagent nozzle wipeout device 11, where the reagent nozzle PB descends to the wipeout height and rotates to the wipeout position G to hit at the wipeout paper 21B. After the secondary reagent adhered to the outer wall of the nozzle has been suctioned, the nozzle PB rises.

Then, the reagent nozzle PB rotates to the reagent dispensing position D and dispenses the secondary reagent into the reaction vessel 6 in which the primary reagent and the sample are dispensed. Simultaneously, the stirring device 12 stirs the inside of the reaction vessel 6 at the stirring position H.

After the secondary reagent has been dispensed, the reagent nozzle PB rotates to the nozzle washing trough position L, descends to the washing water position, and washes the outer wall with the washing water. The inside wall suctioned the reagent is washed with the washing water delivered from the washing syringe of the reagent washing machine 50.

Next, measurement process will be described. When the reaction table 7 rotates at every cycle time for dispensing the sample and the reagent, if the washing water, the reaction tube containing primary reagent and sample, and the reaction tube containing sample, primary reagent and secondary reagent pass through the optical measurement position I, the detector sensor 13 measures all reaction tubes at a prescribed timing, and any calculated values are stored or printed out by printer. The detector sensor disperses the transmitted light at the optical measurement position I into a monochromatic light by diffraction grating. The prescribed monochromatic light is ejected out as a signal by the photo array 56 of light-voltage conversion element.

### INDUTRIAL APLICABILITY

The automatic blood analyzer of the invention is formed as in the above description. Accordingly, the analyzer has excellent effects: it can test many items with a small amount of blood and obtain measured data of high accuracy that are useful for early therapeutic effect.

1. An automatic blood analyzer, comprising the steps of:
after a sample nozzle attached to a sample dispensing device has suctioned a required quantity of a sample for items of measurement from a sample vessel, a liquid adhesion removing portion wiping out the sample adhered to an outer surface of the sample nozzle, and then the sample nozzle being delivered to an upper position of a reaction vessel;
after a required quantity of the sample is dispensed in the reaction vessel, the reaction vessel being delivered to a reagent dispensing position;
after a reagent nozzle has suctioned a prescribed quantity of a reagent according to items of measurement at the reagent dispensing position, the reagent adhered to an outer surface of the reagent nozzle being wiped out by the liquid adhesion removing portion;
thereafter, a required quantity of the reagent being dispensed from the reagent nozzle attached to the reagent dispensing device in the reaction vessel; and,
thereafter, a reaction liquid reacted at a constant temperature being measured by a prescribed wave length,
wherein two dispensing lines of a micro syringe dispensing line dispensing with more than a prescribed quantity of the sample and a pressure dispensing line dispensing with less than a prescribed quantity of the sample are connected with a three-way valve between the sample nozzle and a washing water supply line of the sample dispensing device; and
wherein the micro syringe dispensing line is equipped with a two-way valve and the pressure dispensing line is equipped with a two-way valve and a pressure maintenance portion.

2. An automatic blood analyzer according to claim 1, wherein the two-way valve equipped to the pressure dispensing line is a high-speed plunger valve.

3. An automatic blood analyzer according to claim 2, comprising: the liquid adhesion removing portion having a two-ply fluid absorption tape, a supply reel and a take-up reel for the fluid absorption tape and a means to open the fluid absorption tape in V-formation,
wherein the sample nozzle and the reagent nozzle or a stirrer is inserted in the fluid absorption tape in V-formation for contacting with the fluid absorption tape, and a liquid adhered to the outer surface of the nozzle or the bar is suctioned.

4. An automatic blood analyzer according to claim 1, comprising: the liquid adhesion removing portion having a two-ply fluid absorption tape, a supply reel and a take-up reel for the fluid absorption tape and a means to open the fluid absorption tape in V-formation,
wherein the sample nozzle and the reagent nozzle or a stirrer is inserted in the fluid absorption tape in V-formation for contacting with the fluid absorption tape, and a liquid adhered to the outer surface of the nozzle or the bar is suctioned.
